(19) United States
(12) Patent Application Publication
(10) Pub. No.: US 2003/0197795 A1
(43) Pub. Date: Oct. 23, 2003

(54) Generation and storage of amplified video

(76) Inventor: Charles E. Schinner, Windsor, CO (US)

Correspondence Address: HEWLETT-PACKARD COMPANY, Intellectual Property Administration, P.O. Box 272400, Fort Collins, CO, 80527-2400, US

(21) Appl. No.: 10/128,624

(22) Filed: Apr. 22, 2002

(51) Int. Cl. H04N 5/20

(52) U.S. Cl. 348/255

(57) ABSTRACT

Disclosed herein is a digital video camera for storing video derived from amplified image data.

### BACKGROUND

Digital video cameras typically have optical elements, a photosensor, a data storage device, a controller and a display, all of which are generally mounted in a camera housing. Several types of photosensors are available for converting light to electrical signals in a digital video camera, such as a charge-coupled device (CCD) or an array of complementary metal-oxide semiconductor (CMOS) photodetectors. (The exemplary digital video camera discussed below will contain the latter, a photodetector array.)

The optical elements typically include one or more lenses and/or reflectors. The optical elements focus an image of a scene onto the photodetector array. The photodetector array generates electrical image data representative of the image. The controller processes the image data and transfers it to and from the data storage device. The controller also transfers image data to the display and to output devices such as an external computer, a monitor, etc. Additionally, the controller may sequence the image data to produce video for playback at a later time.

A typical photodetector array contains many photosensitive cells arranged in closely positioned rows and columns. Each photosensitive cell generates image data representative of a small portion of the image focused on the photodetector array. The image data generated by the photosensitive cells is combined to form the entire image, similar to a mosaic. Each photosensitive cell outputs a data value which corresponds to the intensity of light it receives over a given exposure time. The image data is buffered and later processed into a complete set of image data often referred to as a frame. Sequentially captured still frames are sequentially streamed together as video during a play event to show motion.

There are two main factors that affect video quality, the frame rate (or the rate at which image frames are captured) and the quality of each image frame. A typical frame rate for high quality video is thirty frames per second (fps). At this rate the average viewer cannot perceive individual frames, and so seems to see smooth motion in the video. At lower frame rates the average viewer may be able to see the stopped motion of individual frames, thus video captured at low frame rates tends to appear choppy.

Although the frame rate is more important in some ways than individual frame quality, because persistence in the human eye can average out noise or errors in individual frames, the image quality of individual frames can drop below acceptable thresholds, particularly by becoming too dark.

The typical digital video camera contains two main light control mechanisms that affect the brightness in individual frames, an aperture and exposure time. The aperture is an adjustable mechanism like an iris, consisting of thin overlapping plates that are alternately expanded or contracted to change the diameter of a central opening. The aperture is placed in or near the optical elements of the digital video camera in front of the photodetector array. The amount of light passing through the central opening of the aperture to reach the photodetector array can thus be regulated. Apertures are generally adjustable between a small number of discrete positions called f-stops. A smaller f-stop represents a larger aperture opening, which results in a greater amount of light reaching the photodetector array. A larger f-stop represents a smaller aperture opening, which results in a lesser amount of light reaching the photodetector array. Although a large aperture increases brightness of image frames, it also narrows the depth of field, or the range of distances that appear in focus, so it is not always ideal to simply open the aperture to the widest setting to increase image brightness.

The second main light control mechanism is exposure time. This is the amount of time that image light is allowed to fall on the photodetector array for a single frame. Exposure time is typically expressed in fractions of a second (e.g., 1/75th of a second). The shorter the exposure time, the better the ability of the camera to stop subject motion to record one frame, but the less light collected for the image. Thus, exposure time is adjusted to balance the conflicting needs of stopping subject motion and capturing sufficient light for an appropriately bright image.

Additionally, increasing the exposure time to allow for bright images may require that the frame rate be reduced to allow for the additional exposure time of each frame. That is, with a long exposure time for each frame, there may not be enough time to capture, process and store thirty frames in a single second.

The aperture and exposure time are adjusted as needed to control image brightness while managing other related considerations such as depth of field and stopping subject motion, etc. Auto exposure (AE) algorithms may be used to entirely or partially control the light adjustment mechanisms of the digital video camera, including aperture and exposure time. The digital video camera having an adjustable aperture and exposure time, likely under automatic control, is thus able to capture video over a wide range of normal well-lit conditions.

However, typical digital video cameras are not able to capture quality video of dimly-lit subjects. The long exposure times required to capture sufficiently bright frames would result in streaky images of moving subjects and would require unacceptably low frame rates. Digital video cameras may be equipped with lights which continually illuminate a subject, but these tend to produce a spotlight affect in the video, require a great deal of power, and can be irritating or inappropriate in some situations.

### SUMMARY

In one exemplary embodiment disclosed herein, an electronic imaging device may include an image capture device, a programmable variable gain amplifier (either analog, digital, or both) coupled to the image capture device for adjusting a magnitude of an electrical signal, and a memory device for storing video derived from the adjusted electrical signal.

In another exemplary embodiment disclosed herein, a digital video camera may include an image capture device emitting an analog signal, an analog programmable variable gain amplifier coupled to the image capture device for adjusting a magnitude of the analog signal, and a memory device for storing digital video derived from the amplified analog signal.

### BRIEF DESCRIPTION OF THE DRAWING

Illustrative and presently preferred embodiments are illustrated in the drawing in which:

FIG. 1 is an exemplary block diagram of a digital video camera.

FIG. 2 shows a high level flowchart illustrating an exemplary algorithm for manually adjusting the gain of video image data.

FIG. 3 shows a high level flowchart of an exemplary process for providing automated gain of video image data.

### DETAILED DESCRIPTION

Generation and storage of amplified video enables a video camera to operate in low light environments by amplifying the signal carrying video image data and storing the resulting amplified image signal. A programmable variable-gain amplifier is placed in the image pipeline between the photodetector array (or its functional equivalent) and a storage medium. When the video camera detects a low light condition or a low level in the image signal, the variable-gain amplifier is programmed to amplify the image signal. The variable-gain amplifier may also be manually programmed if that feature is desirable in the video camera.

The image signal can be amplified by the variable-gain amplifier as needed to produce visible details in the resulting individual image frames and overall video, even to the point at which it introduces color shift or noise in the image frames. Note that some color shift or noise in individual image frames will not be visible to most viewers of a video stream, because the persistence of the viewers eye tends to average out errors in individual image frames. In addition, it can be more important to the user to capture lower quality but bright and distinct video than high quality but overly dark video. Generation and storage of amplified video enables the video camera to maintain the maximum possible frame rate even in low light conditions and to minimize image smear due to subject motion. Generation and storage of amplified video can likely be performed using existing components in most video cameras, adding functionality with little cost.

The exemplary embodiment described herein amplifies the image signals in a digital video camera. However, generation and storage of amplified video is not limited to use with a digital video camera, but may be used in any image capture device in which the image data can be electrically amplified, including non-digital video cameras, still cameras with video capture capabilities, etc.

The image signal in a digital video camera may be amplified in any suitable manner, including using an analog amplifier between the photodetector array and an analog-to-digital (A/D) converter, or using a digital multiplier after the A/D converter, for example. A suitable exemplary method of amplifying image data in a digital still camera is described in U.S. patent application Ser. No. 09/661,883, filed on Sep. 14, 2000, for a “DIGITAL CAMERA AND METHOD OF IMPROVING IMAGE QUALITY IN LIVE VIEW MODE” of Schinner et al., which is hereby incorporated by reference for all that is contained therein. The above-referenced patent application discloses an apparatus and method for improving image quality in a live view mode. The live view mode may be described as a mode in which amplified image data is sent to a liquid crystal display to aid a user in capturing a still image of an object. During the live view mode, the amplified image data is only sent to the liquid crystal display and is not stored in memory. When the image is captured, amplification of the image data is turned off to capture the highest possible quality image.

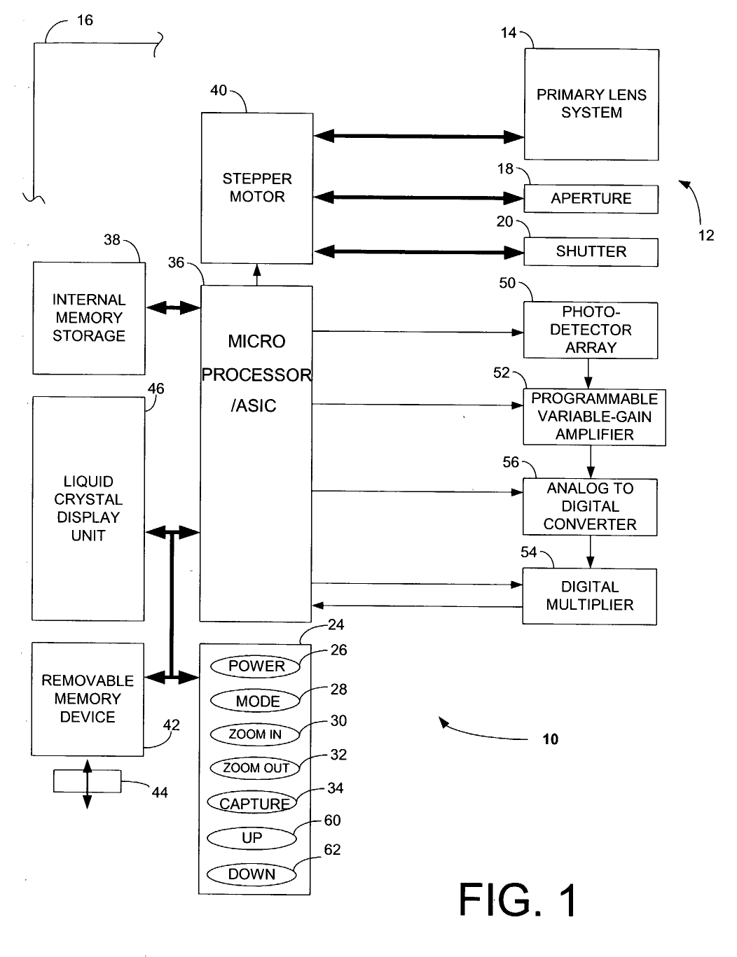

Referring now to the drawing and more particularly to FIG. 1, there is illustrated an exemplary digital video camera 10, which is constructed in accordance with one exemplary embodiment of the present system. The digital video camera 10 may operate in four modes of operation: 1) a video capture mode of operation wherein video may be captured when the user presses a capture button 34, 2) a review mode wherein stored video is retrieved and displayed for review by the user; 3) a connect mode wherein the camera may be coupled to a personal computer, stand alone monitor, or other type of communication device that accepts video for storage or display purposes; and 4) a still capture mode of operation wherein a still photograph may be captured when the user presses the capture button 34.

The digital video camera 10 may include a housing 16 having mounted therein a lens/aperture system 12 that facilitates zooming, aperture adjustments and image focusing. The lens/aperture system 12 includes a primary lens system 14 for focusing and optically zooming a scene to be captured. The lens/aperture system 12 also includes an aperture 18 for adjusting the amount of light passing therethrough and a shutter 20 for regulating the light reaching the photodetector array 50.

The digital video camera 10 is controlled by a set of buttons on a control panel 24 mounted within the housing 16. The digital video camera 10 may be provided with buttons such as a power on/off button 26, a mode selection button 28, a zoom in button 30, a zoom out button 32 and a capture button 34.

The digital video camera 10 may also include a microprocessor 36, an internal memory storage unit 38 for storing program code and images, a stepper motor 40 responsive to the microprocessor 36 for controlling the lens/aperture system 12, shutter 20, a removable memory device 42 for receiving a memory card 44 to store image data (video and/or images), and a liquid crystal display (LCD) 46 for displaying images and messages. The microprocessor 36 may be of any type suitable for controlling the digital video camera 10, including a general-purpose processor or an Application Specific Integrated Circuit (ASIC).

The digital video camera 10 includes amplification components including a programmable variable-gain amplifier 52, an analog-to-digital (A/D) converter 56, and a digital multiplier 54. The photodetector array 50 produces an analog electrical signal representative of the image entering the digital video camera 10. Because the electrical signal produced by the photodetector array 50 is weaker than many A/D converters (e.g. 56) require, typical digital video cameras include an analog amplifier with a constant gain factor to amplify the output of the photodetector array 50 for the A/D converter (e.g., 56). A constant gain factor has been used in the past to optimize image quality over a typical range of light conditions, and the gain factor is not adjusted according to varying lighting conditions. As mentioned above, variable amplification of the image signal can introduce or increase noise and other errors in the image data. This variable amplification may result in video of lower quality than that captured with better lighting, but it enables the user to capture otherwise unobtainable video in low light conditions without supplementary lighting.

In the exemplary embodiment of the present system, a programmable variable-gain amplifier 52 (controlled by the microprocessor/ASIC 36) is placed between the photodetector array 50 and the A/D converter 56 to variably amplify the analog electrical signal between them. Under low light conditions, the programmable variable-gain amplifier 52 may be programmed with a greater gain factor to amplify the electrical signal from the photodetector array 50, thus increasing the brightness of the resulting video.

The analog electrical image signal from the programmable variable-gain amplifier 52 is converted to a digital electrical image signal in the A/D converter 56. The A/D converter 56 samples the incoming analog signal at regular intervals and produces a stream of numbers representing the changing signal levels at the input. Thus, a low level electrical signal at the input results in a small number, and a high level electrical signal at the input results in a large number.

The resulting digital electrical signal from the A/D converter 56 may be processed by the digital multiplier 54 to scale the signal to the desired range, effectively amplifying the image data.

The microprocessor 36 is electrically coupled to the photodetector array 50, the programmable variable-gain amplifier 52, the A/D converter 56, and the digital multiplier 54 to control the amplification of the image data before it is stored in a memory device such as the internal memory 38 or memory card 44.

It should be apparent to those skilled in the art of electronic amplification that the image signal can be amplified with either the programmable variable-gain amplifier 52 or digital multiplier 54 or both, balancing the need for amplification with the components available in the particular digital video camera. Because the sensitivity of the photodetector array 50 is constant, the programmable variable-gain amplifier 52 should be adjusted so that image signal is well within the input range of the A/D converter 56 so that both the low and high end of the image data falls is detectable by the A/D converter 56, preventing clipping of the image data at either the low or high end. For example, the programmable variable-gain amplifier should be adjusted so that the maximum signal level is not greater than the maximum input level of the A/D converter 56. Thus, analog amplification can be performed by the programmable variable-gain amplifier 52 only up to the maximum input level of the A/D converter 56.

Similarly, amplification can be performed in the digital multiplier 54 only up to a certain level before clipping occurs, removing the upper portion of the digital image signal. Selecting whether to use analog amplification or digital multiplication is a design choice available to the digital video camera designer, but including at least some analog amplification may be advisable based on the sensitivity of the A/D converter 56.

As the lighting condition may vary over time, the designer of the digital video camera may cause the digital video camera to evaluate the brightness and readjust the amplification either continually or at predetermined intervals.

The programmable variable-gain amplifier 52 in one non-limiting exemplary embodiment has a gain range between a minimum (Gmin) of about −3.3 dB and a maximum (Gmax) of about 34.8 dB. The default gain factor for the programmable variable-gain amplifier 52 is fixed at a predetermined level or nominal gain factor (Gnom) at the time of camera manufacture. For example, the programmable variable-gain amplifier 52 may be set in an exemplary, non-limiting embodiment at Gnom of about 11.4 dB. (Note that the required gain range and the optimal default gain factor is dependent upon the specifications of other components in the system, including the photodetector array 50 and A/D converter 56.)

The digital video camera 10 begins to amplify the image signal when overly dark image frames are generated after setting the aperture 18 at the largest lens aperture (wherein maximum light reaches the photodetector array 50 ) and the exposure time for the photodetector array 50 at a maximum to maintain a desirable frame rate. In one exemplary embodiment, this maximum exposure time is about 1/75th of a second, resulting in a frame rate of 30 fps in the exemplary digital video camera.

Details about designing or programming the digital video camera 10 to amplify the image signal in low light conditions are application specific, thus a detailed generic description is not given. However, exemplary manual and automatic control of image signal amplification in the digital video camera 10 will be described below.

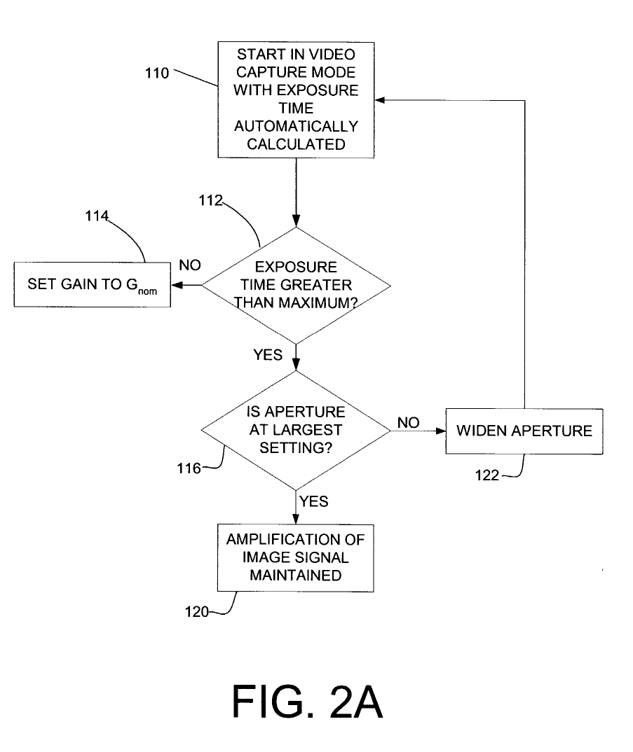

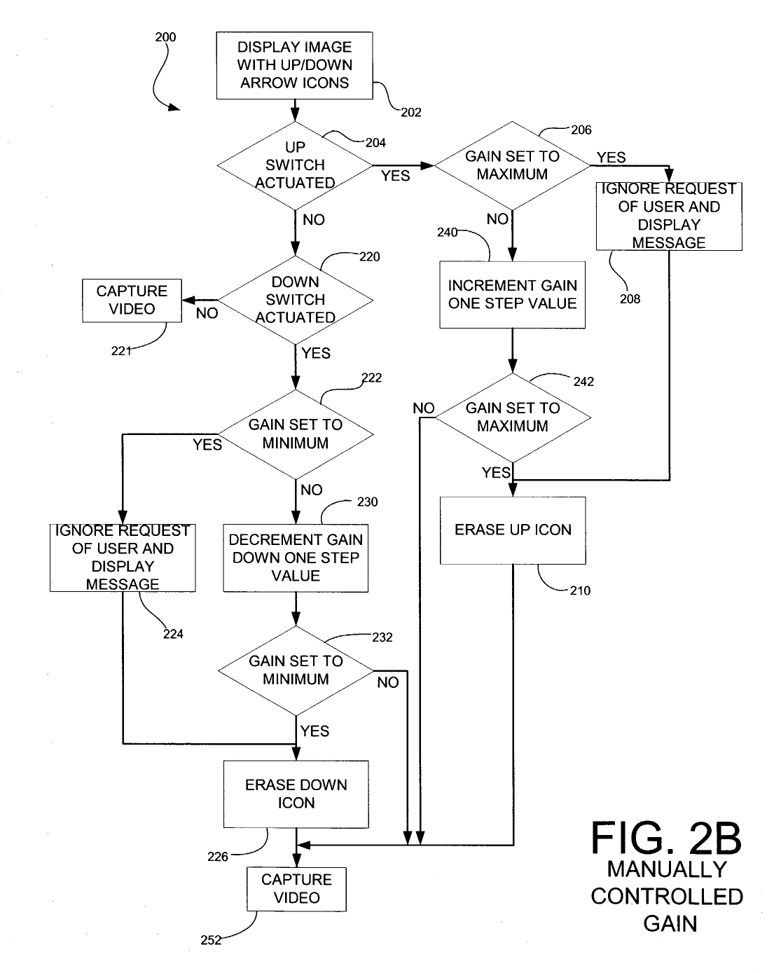

Referring now to FIG. 2A, an exemplary determination of whether amplification of the image signal is needed in the digital video camera 10 will be described. The digital video camera 10 is placed in video capture mode 110 with the exposure time automatically calculated. The digital video camera 10 calculates the appropriate exposure time based at least in part on the brightness of the light incident on the photodetector array 50, with a nominal gain setting Gnom for the image signal. Note that the automatically calculated exposure time is an ideal exposure time, and the digital video camera 10 automatically selects the closest available exposure time. Thus, the automatically calculated exposure time in low light conditions may be too long to fit within the desired frame rate, requiring that the frame rate be reduced or the image signal amplified.

If 112 the automatically calculated exposure time is not greater than the maximum possible exposure time, the gain factor for amplification of the image signal is set 114 to the default gain factor Gnom. That is, if the automatically calculated exposure time is within the available range of exposure times, the digital video camera 10 is not in light conditions low enough to warrant amplification of the image signal.

If 112 the automatically calculated exposure time is greater than the maximum available exposure time and if 116 the aperture is set at the widest setting, amplification of the image signal is warranted 120 due to low light conditions. If the automatically calculated exposure time is within the available range of exposure times but the aperture can be opened wider, the digital video camera 10 will first widen 122 the aperture before indicating that amplification of the image signal is warranted.

Thus, the digital video camera 10 first determines whether the two main light control mechanisms, exposure time and aperture setting, are set at their maximum brightness settings before indicating that amplification is warranted 120.

If amplification of the image signal is warranted 120, the digital video camera 10 can either prompt the user to manually adjust the image signal amplification or can initiate automatic image signal amplification.

Manually Controlled Gain

In the event that the image signal amplification is warranted due to low light conditions, the user may be prompted to manually adjust the gain of either the programmable variable-gain amplifier 52, the digital multiplier 54, or both. A user interface may be provided enabling the user to adjust image brightness, and the microprocessor or ASIC 36 controls the programmable variable-gain amplifier 52 and/or digital multiplier 54 based on the user input. During the manual gain adjustment process 200 illustrated in FIG. 2B, a user may manually adjust the image brightness and monitor the results of the adjustment on the liquid crystal display 46.

The user interface may include an overlay icon (not shown), a graphical display superposed over the image on the LCD 46 like a watermark to provide feedback. The user adjusts gain or image brightness by pressing buttons on the digital video camera 10 such as up and down buttons 60, 62 (FIG. 1). Each time the up button 60 is depressed, the gain of the programmable variable-gain amplifier 52 and/or digital multiplier 54 increases in incremental steps (for example, in 3 dB steps) until a maximum overall gain is reached.

Note again that the image signal may be amplified by either the programmable variable-gain amplifier 52 or digital multiplier 54 or both, according to the digital video camera 10 design. For example, in one exemplary embodiment, the gain in the programmable variable-gain amplifier 52 may first be increased until the gain reaches Gmax (for example, a Gmax value of 34.8 dB). At that point, if the user continues to press the up button 60, the multiplier factor in the digital multiplier 54 may be increased in incremental steps until the peaks in the resulting image reach or near the maximum possible values.

The down switch 62 decreases the gain of the programmable variable-gain amplifier 52 and/or digital multiplier 54 by a similar value (for example, a 3 dB step value) until the minimum overall gain setting is reached, such as a gain of Gmin (about −3.3 dB) in the programmable variable-gain amplifier 52 and a multiplier factor of one or lower in the digital multiplier 54.

It should be noted that the gain constants of the programmable variable-gain amplifier 52 and/or digital multiplier 54 are dictated by the camera design because performance varies from camera to camera due to differences between lens, photodetector array, LCD and other camera components.

Referring to FIG. 2B, the manual gain setting process 200 begins by displaying 202 an image on the LCD 46, perhaps with additional graphical information about gain or image brightness. For example, up and down arrows may be displayed over the image on the LCD 46 indicating that the gain may be increased or decreased. (E.g., if the gain can be increased, the up arrow is displayed, if the gain is at a maximum value, the up arrow disappears.) After displaying 202 the image, an “up button-actuated” decision 204 may be provided. If the up button 60 is activated, the outcome of the “up button-actuated” decision 204 is positive and a “gain set to maximum” decision 206 may be provided. If the gain of the programmable variable-gain amplifier 52 and/or digital multiplier 54 is already at a maximum, for example Gmax, then an “ignore user request and “display message” step 208 may be provided. After ignoring the user's request to increase the gain in step 208, the icon may be erased during an “erase up icon” step 210, and video may be captured 252.

Referring back to the “up button-actuated” decision 204, in the event that the up button 60 is not actuated, the outcome of the “up button-actuated” decision 204 is negative. With a negative outcome from the “up button-actuated” decision 204, a “down button-actuated” decision 220 may be provided. If the down button 62 is not activated, the outcome to the “down button-actuated” decision 220 is negative. In the event that the down button 62 is actuated, the outcome of the “down button-actuated” decision 220 is positive. With a positive outcome from the “down button-actuated” decision 220, a “gain set to minimum” determination 222 may be provided. If the gain of the programmable variable-gain amplifier 52 and/or digital multiplier 54 is at a minimum value Gmin, then the outcome is positive and an “ignore user request and display message” step 224 may be provided. After step 224, an “erase down icon” step 226 may be provided, and video may be captured 252.

Referring back to the “gain set to minimum” decision 222, if the gain is not set to a minimum, then the outcome is negative. With a negative outcome to decision 222, a “decrement gain down one value” step 230 may be provided. As previously described, this value may be any discrete value such as 3 dB. After providing step 230, a “gain set to minimum decision” 232 may be provided. If the gain is not set to a minimum, the outcome of decision 232 is negative, and video may be captured. In the event that the gain is set to a minimum, the outcome of decision 232 is positive and the “erase down icon” step 226 may be provided.

Referring back to the “gain set to maximum” decision 206, in the event that the gain is set to a maximum, the outcome of decision 206 is negative and an “increment gain one value” step 240 may be provided. As previously described, this value may be any discrete value such as 3 dB . After adjusting the gain in the programmable variable-gain amplifier 52 and/or digital multiplier 54, a “gain set to maximum decision” 242 may be provided. In the event that the gain is set to a maximum, the outcome to decision 242 is positive and the “erase up icon” step 210 may be provided. In the event that the gain is not set to a maximum, the outcome to decision 242 is negative and video may be captured 252.

Automated Gain

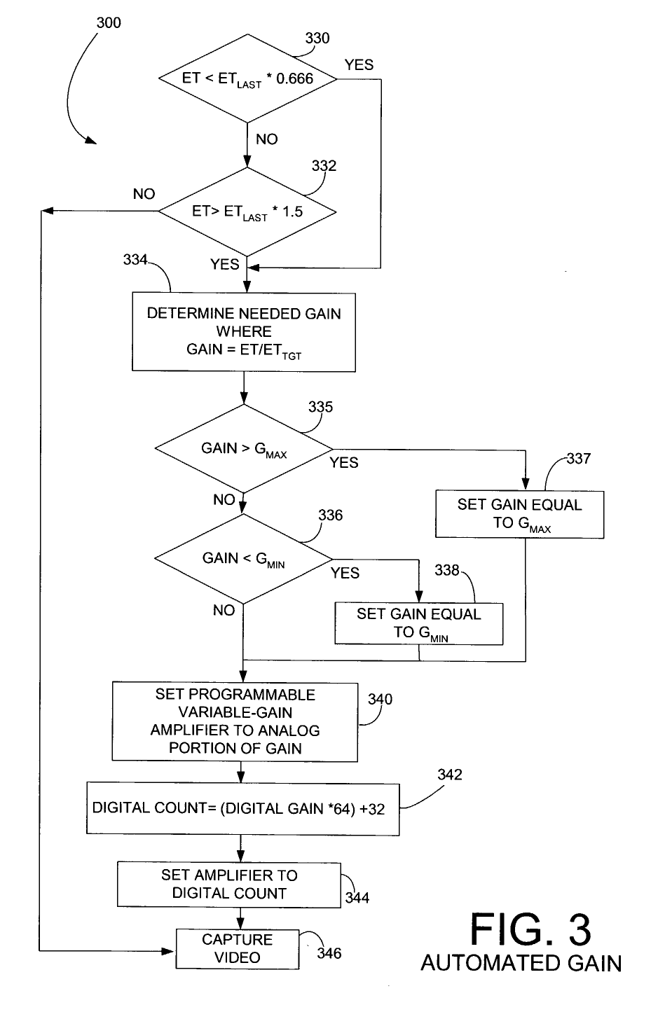

If amplification of the image signal is warranted (see FIG. 2A) and the digital video camera 10 is in an automatic gain control mode, a process such as the exemplary process of FIG. 3 may be executed. The automated gain control process 300 automatically adjusts the gain of the programmable variable-gain amplifier 52 and/or digital multiplier 54 in lieu of the manual gain control process 200 (FIG. 2B).

Referring now to FIG. 3, the automatic gain control process 300 only adjusts the gain when a substantial change is needed, to prevent too frequent minor changes which could be distracting in the resulting video and which could cause oscillations in the gain value. To implement this hysteresis in the gain control process, the digital video camera 10 determines whether the automatically calculated exposure time (ET) is less 330 than the previously calculated exposure time (ET_{Last}) multiplied by 0.666 or greater 332 than the previously calculated exposure time (ET_{Last}) multiplied by 1.5. Note that ET is calculated by the auto-exposure algorithm.

If the automatically calculated exposure time is within the range between 0.666 and 1.5 times the previously calculated exposure time, the digital video camera 10 proceeds directly to capturing video 346 without adjusting the gain for the image signal. If, however, the automatically calculated exposure time (ET) has changed enough from the previously calculated exposure time to fall outside this range, the digital video camera 10 calculates 334 the required gain according to the automatically calculated exposure time.

In the exemplary embodiment, the required gain is calculated 334 by dividing the automatically calculated exposure time by the desired target exposure time (ET_{Tgt}). For example, if the desired target exposure time is 1/75 of a second and the automatically calculated exposure time is 1/25 of a second (too long to allow 30 fps), the gain is calculated by dividing 1/25 by 1/75 for a required gain of 3.

(The automatically calculated exposure time (ET) may be stored in the digital video camera 10 over the previously calculated exposure time ET_{Last} after their use in calculating gain.)

The digital video camera 10 then determines whether the calculated gain is within the possible gain range. If 335 the calculated gain is greater than the maximum possible gain, the gain is set 337 to the maximum possible gain value. If 336 the calculated gain is less than the minimum possible gain, the gain is set 338 to the minimum possible gain value.

As discussed above, the gain can be applied either in the programmable variable-gain amplifier 52 or the digital multiplier 54 or both. In this exemplary embodiment, the gain is divided into an analog portion and a digital portion. The analog portion of the calculated gain will be applied in the programmable variable-gain amplifier 52 with the digital portion applied in the digital multiplier 54. The division of the gain between the two components 52 and 54 will not be discussed, other than as mentioned above, it depends in part upon the input range of the A/D converter 56 and the output range from the digital multiplier 54.

The analog portion of the gain is therefore applied 340 by programming the programmable variable-gain amplifier 52 to provide that partial gain to the image signal. The programming of the programmable variable-gain amplifier 52 is device specific and may require converting the gain factor into other units such as dB.

To program the digital multiplier 54 to provide the remaining digital gain, the digital count (the number used to multiply the digital image signal) must be calculated. In order to provide a better understanding of the digital count calculation, it should be understood that given a sixteen bit word, a maximum digital count of 65535 is possible relative to a gain range between about −0.5 and about 1000. In this regard the digital count can be plotted on an x-y axis graph to provide a straight line approximation. The straight line is represented by the following equation:

$$y - {y}_{0} = \frac{Δ y}{Δ x} ( x - {x}_{0} )$$

where A=(−0.5, 0) and B=(1000, 65535)

$$\begin{matrix}y - 0 = ( \frac{65535 - 0}{1000 - ( - 0.5 )} ) ( x - ( - 0.5 ) ) \\ y = \frac{65535}{1000.5} x + 32.7511\end{matrix}$$

Digital Count=65.5022*Digital Gain+32.7511

While the above real number expressions are satisfactory, it will be understood by those skilled in the art that utilization of integer mathematics is simpler and easier. The coefficients are therefore rounded to integers keeping the digital count within the range of 0 to 65535 to arrive at the expression:

Digital Count = 64 × Digital Gain + 32

| Gain | Digital Count |
|---|---|
| −0.5 | 0 |
| 0 | 32 |
| 1000 | 64032 |

Once the digital count is calculated 342 the microprocessor or ASIC 36 configures 344 the digital multiplier 54 with the desired digital count setting. The digital video camera 10 is then ready to generate and store 346 amplified video.

It should be understood that in lieu of performing mathematical calculations to determine analog gain and the digital count, other methods such as a look up table method could also be used.

The digital video camera 10 may be provided with a control to turn off automatic or manual amplification of the image signal.

The digital video camera previously described allows a user to capture video at an acceptable frame rate when lighting conditions are low. Even though the aperture and capture times are maximized, the digital video camera can generate and store video during these lighting conditions by amplifying the image signal.

While illustrative and presently preferred embodiments of the invention have been described in detail herein, it is to be understood that the inventive concepts may be otherwise variously embodied and employed and that the appended claims are intended to be construed to include such variations except insofar as limited by the prior art. For example, the storage of amplified video data descried above with respect to a digital video camera may be applied to any suitable imaging device, such as a non-digital video camera or a digital still camera in video capture mode.

I claim:

1. An electronic imaging device comprising:
an image capture device;
a programmable amplifier coupled to said image capture device for adjusting a magnitude of an electrical signal; and
a memory device for storing video derived from said adjusted electrical signal.

2. The electronic imaging device of claim 1, wherein said programmable amplifier adjusts said magnitude at least partially based on a frame rate of said video.

3. The electronic imaging device of claim 1, wherein said magnitude of said electrical signal comprises a multiplier factor when implemented in a digital domain.

4. The electronic imaging device of claim 1, wherein said magnitude of said electrical signal comprises a gain factor when implemented in an analog domain.

5. The electronic imaging device of claim 1, and further comprising:
an analog to digital converter coupled to said image capture device for converting said electrical signal into a digital signal; and
a digital multiplier coupled to said analog to digital converter for increasing said magnitude of said digital signal.

6. The electronic imaging device of claim 5, wherein said digital multiplier comprises a microprocessor.

7. The electronic imaging device of claim 5, wherein said digital multiplier comprises a hardware multiplier.

8. The electronic imaging device of claim 1, wherein said programmable amplifier is coupled to a microprocessor having a gain control algorithm for calculating an amplification applied to said electrical signal to produce said video at a predetermined frame rate.

9. The electronic imaging device of claim 1, wherein said programmable amplifier is coupled to a microprocessor coupled to a stored look up table for determining an amplification applied to said electrical signal to produce said electrical signal to produce said video at a predetermined frame rate.

10. The electronic imaging device of claim 1, and further comprising:
at least one manual amplification selector operably associated with said programmable amplifier.

11. A method for storing video image data, comprising:
converting light to an electrical signal;
amplifying said electrical signal; and
storing said video image data derived from said amplified electrical signal.

12. The method of claim 11, wherein said amplifying said electrical signal is adjusted at least partially based on a frame rate associated with said video image data.

13. The method of claim 11, wherein said amplifying said electrical signal comprises amplifying said electrical signal by an incremental step value.

14. The method of claim 11, wherein said amplifying said electrical signal by said incremental step value terminates when a predetermined maximum strength level is reached.

15. A method of making an image capture device comprising:
providing a camera housing;
mounting a photosensor in said camera housing;
connecting a programmable amplifier to said photosensor for adjusting a magnitude of an electrical signal produced by said photosensor; and
operatively associating a memory device with said programmable amplifier for storing video derived from said adjusted electrical signal.

16. An apparatus for producing video comprising:
means for converting light to an electrical signal;
means for converting said electrical signal to video having a frame rate;
means for algorithmically magnifying said electrical signal as a function of said frame rate.

17. A digital video camera comprising:
an image capture device emitting an analog signal;
an analog to digital converter coupled to said image capture device for converting said analog signal into a digital signal;
a digital multiplier coupled to said analog to digital converter for increasing a magnitude of said digital signal; and
a memory device for storing video derived from said increased digital signal.

18. The digital video camera of claim 17, wherein said digital multiplier comprises a microprocessor.

19. The digital video camera of claim 17, wherein said digital multiplier comprises a hardware multiplier.

20. A digital video camera comprising:
an image capture device emitting a signal;
an analog programmable amplifier coupled to said image capture device for adjusting a magnitude of said signal; and
a memory device for storing digital video derived from said adjusted signal.

21. The digital video camera of claim 20, wherein said analog programmable amplifier is coupled to a microprocessor having a gain control algorithm for calculating an amplification applied to said signal to produce said video at a predetermined frame rate.

22. The digital video camera of claim 20, wherein said programmable amplifier is coupled to a microprocessor coupled to a stored look up table for determining an amplification applied to said signal to produce said signal to produce said video at a predetermined frame rate.

23. The digital video camera of claim 20, and further comprising:
at least one manual amplification selector operably associated with said analog programmable amplifier.
